(19) United States
(12) Patent Application Publication
(10) Pub. No.: US 2013/0042736 A1
(43) Pub. Date: Feb. 21, 2013

(54) CUTTING MACHINE AND POSITIONING METHOD THEREOF FOR POSITIONING LIQUID CRYSTAL PANEL

(71) Applicants: Hongtao Deng, Shenzhen (CN); Tsung-i Hung, Shenzhen (CN); Cheng-ming Huang, Shenzhen (CN)

(72) Inventors: Hongtao Deng, Shenzhen (CN); Tsung-i Hung, Shenzhen (CN); Cheng-ming Huang, Shenzhen (CN)

(73) Assignee: Shenzhen China Star Optoelectronics Technology Co., Ltd., Shenzhen (CN)

(21) Appl. No.: 13/380,049

(22) PCT Filed: Oct. 31, 2011
(86) PCT No.: PCT/CN11/81557

§ 371 Date: Dec. 22, 2011

(30) Foreign Application Priority Data
Aug. 19, 2011 (CN) 201110239945.5

(51) Int. Cl. B26D 5/20; B65G 37/00

(52) U.S. Cl. 83/202; 414/800

(57) ABSTRACT

A cutting machine for cutting a liquid crystal panel includes a transferring device for transferring the panel, a positioning device for positioning the panel, and a main body for driving the transferring device and the positioning device to position the panel and for cutting the panel after the panel is positioned. The transferring device includes a first roller array for supporting and transferring the panel along a first direction and a second roller array for supporting and transferring the panel along a second direction. The positioning device includes a first positioning assembly, a second positioning assembly, a third positioning assembly, and a forth positioning assembly. The first positioning assembly cooperates with the second positioning assembly to position the panel along the first direction before the panel is cut, and the third positioning assembly cooperates with the forth positioning assembly to position the panel along the second direction.

### BACKGROUND

1. Technical Field

The present disclosure relates to manufacturing technologies of liquid crystal displays, and particularly, to a cutting machine for a liquid crystal panel and a positioning method thereof for positioning the liquid crystal panel.

2. Description of Related Art

With the development of liquid crystal display (LCD) technology, a size of a liquid crystal panel of the LCD has become larger and lager to cause the liquid crystal panel to become heavier and heavier. In the manufacturing process of the liquid crystal panel, an air floating transferring device is often used for transferring the liquid crystal panel to a predetermined position to be cut after a vacuum bonding process. Since the liquid crystal panel becomes heavier, the transferring device cannot float the liquid crystal panel high enough, thus, the liquid crystal panel may easily contact the transferring device in the transferring process to generate an unwanted friction therebetween. In this state, a jet positioning device used for pushing the liquid crystal panel may not be able to push the liquid crystal panel to an accurate position, which reduces the cutting precision of the cutting machine.

### SUMMARY

The present disclosure provides a cutting machine for a liquid crystal panel. The cutting machine includes a transferring device for transferring the panel, a positioning device for positioning the panel, and a main body for driving the transferring device and the positioning device to position the panel and for cutting the panel after the panel is positioned. The transferring device includes a first roller array for supporting and transferring the panel along a first direction and a second roller array for supporting and transferring the panel along a second direction. The positioning device includes a first positioning assembly, a second positioning assembly, a third positioning assembly, and a forth positioning assembly, the first positioning assembly cooperates with the second positioning assembly to position the panel along the first direction before the panel is cut, the third positioning assembly cooperates with the forth positioning assembly to position the panel along the second direction.

The present disclosure further provides a positioning method for positioning the liquid crystal panel. The positioning method includes the following steps:
providing a first roller array, a first positioning assembly and a second positioning assembly cooperating with the first roller array for positioning the panel along a first direction;
providing a second roller array, a third positioning assembly, and a forth positioning assembly, lifting the second roller array, and positioning the liquid crystal panel along a second direction via cooperation between the second roller array and the third positioning assembly and the forth positioning assembly.

The present disclosure further yet provides another cutting machine for a liquid crystal panel. The cutting machine includes a transferring device for transferring the panel, a positioning device for positioning the panel, and a main body for driving the transferring device and the positioning device to position the panel and for cutting the panel after the panel is positioned. The transferring device includes a first roller array for supporting and transferring the panel along a first direction and a second roller array for supporting and transferring the panel along a second direction. The first roller array includes a plurality of evenly-spaced first roller rows parallel to each other in the first direction, each first roller row includes a plurality of first rollers arranged in order via a first rotating shaft, and each first roller is capable of rotating in the first direction under the driving of the first rotating shaft. The second roller array includes a plurality of evenly-spaced second roller rows parallel to each other in the second direction, each second roller row includes a plurality of second rollers arranged in order via a second rotating shaft, and each second roller is capable of rotating in the second direction under the driving of the second rotating shaft. The positioning device includes a first positioning assembly, a second positioning assembly, a third positioning assembly, and a forth positioning assembly, the first positioning assembly cooperates with the second positioning assembly to position the panel along the first direction before the panel is cut, the third positioning assembly cooperates with the forth positioning assembly to position the panel along the second direction.

Preferably, the first roller array is a power motivated roller array, and each first roller is driven to rotate when the main body drives the first rotating shaft to rotate.

Preferably, the second roller array is a non-power motivated roller array, and each second roller is driven to rotate by a friction generated between a surface thereof and the panel.

Preferably, a first space defined between two adjacent first roller rows is larger than a thickness of each second roller along the first direction, two adjacent second rollers in each second roller row are capable of rotating relative to each other freely, a second space defined between two adjacent second rollers in each second roller row is larger than a diameter of each first roller along the first direction, and the diameter of the each first roller is smaller than that of each second roller.

Preferably, the second roller array is located under the first roller array, and the second roller array is capable of moving upwards and downwards relative to the first roller array along a third direction perpendicular to the first direction and the second direction.

Preferably, the panel includes a first side, a second side opposite to the first side in the first direction, a third side, and a forth side opposite to the third side in the second direction; the first positioning assembly, the second positioning assembly, the third positioning assembly, and the forth positioning assembly are located above the transferring device, the first positioning assembly and the second positioning assembly respectively correspond to the first side and the second side for pushing the first side and the second side along the first direction and a direction opposite to the first direction respectively, the third positioning assembly and the forth positioning assembly respectively correspond to the third side and the forth side for pushing the third side and the forth side along the second direction and a direction opposite to the second direction respectively.

Preferably, the first positioning assembly includes a first air cylinder, a first stopper, and a second stopper, the first stopper and the second stopper are connected to the first air cylinder, and the first positioning assembly is capable of applying a first external force along the first direction to the first side of the panel when the first air cylinder pushes the first stopper and the second stopper; the second positioning assembly includes a second air cylinder, a third stopper, and a forth stopper, the third stopper and the forth stopper are connected to the second air cylinder, and the second positioning assembly is capable of applying a second external force along a direction opposite to the first direction to the second side of the panel when the second air cylinder pushes the third stopper and the forth stopper; the third positioning assembly includes a third air cylinder, a fifth stopper, and a sixth stopper, the fifth stopper and the sixth stopper are connected to the third air cylinder, and the third positioning assembly is capable of applying a third external force along the second direction to the third side of the panel when the third air cylinder pushes the fifth stopper and the sixth stopper; and the forth positioning assembly includes a forth air cylinder, a seventh stopper, and an eighth stopper, the seventh stopper and the eighth stopper are connected to the first air cylinder, and the forth positioning assembly is capable of applying a forth external force along a direction opposite to the second direction to the forth side of the panel when the forth air cylinder pushes the seventh stopper and the eighth stopper.

In the positioning method of the present disclosure, the transferring device and the positioning device are capable of respectively positioning the liquid crystal panel in the first direction and the second direction. Therefore, a situation where the liquid crystal panel of large size cannot be positioned precisely can be avoided somewhat and thus the cutting accuracy of the cutting machine can be improved.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a top view of a transferring device of a cutting machine in accordance with an embodiment of the present disclosure.

FIG. 2 is a top view of a positioning device of the cutting machine of FIG. 1.

FIG. 3 is a flow chart of a positioning method of positioning a liquid crystal panel.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

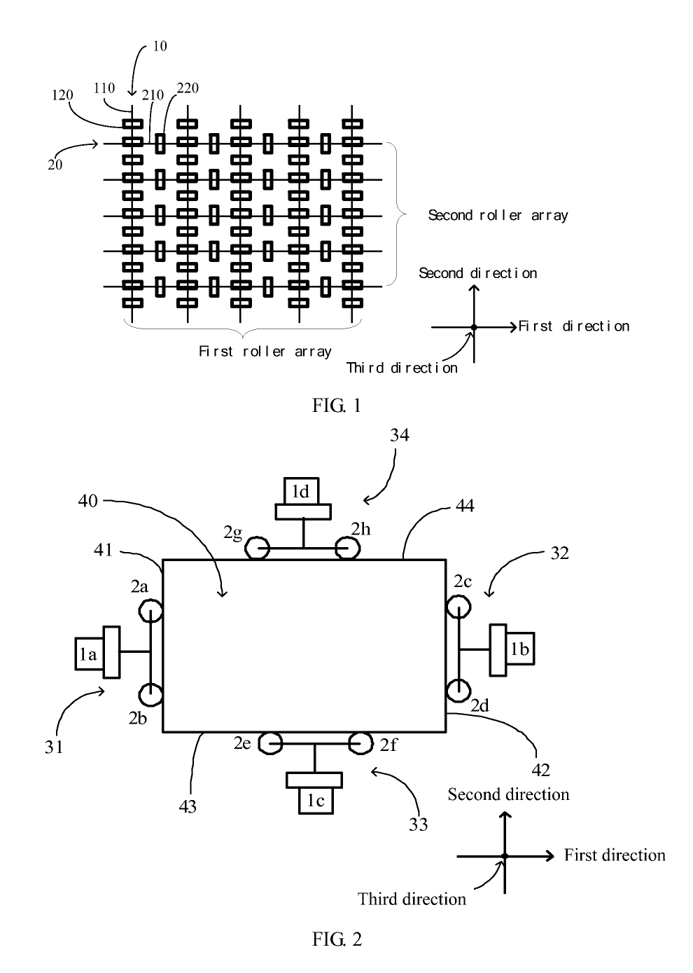

Referring to FIG. 1, a cutting machine for cutting a liquid crystal panel includes a main body (not shown), and a transferring device and a positioning device disposed on the main body. The main body is used for controlling the transferring device and the positioning device to position the liquid crystal panel.

The transferring device includes a first roller array for supporting the liquid crystal panel and further transferring the liquid crystal panel in a first direction (the direction along which the liquid crystal panel moves into the cutting machine), and a second roller array for supporting the liquid crystal panel and further transferring the liquid crystal panel in a second direction perpendicular to the first direction.

The first roller array comprises a number of evenly-spaced first roller rows 10 parallel to each other in the first direction. Each first roller row 10 includes a number of first rollers 120 arranged in order via a first rotating shaft 110, thus, each first roller 120 is capable of rotating in the first direction when the first rotating shaft 110 rotates. In the embodiment, the first roller array is a power motivation roller array. That is, the first rotating shaft 110 is driven to rotate under a driving device (not shown) disposed in the main body for rotating each first roller 120.

The second roller array is capable of moving upwards and downwards relative to the first roller array. That is, the second roller array is capable of moving along a third direction perpendicular to a surface defined by the first roller array. In the embodiment, the second roller array is driven to move by an air cylinder. In other embodiments, the second roller array can be driven to move by other driving systems. The second roller array includes a number of evenly-spaced second roller rows 20 parallel to each other in the second direction. Each second roller row 20 includes a number of second rollers 220 arranged in order via a second rotating shaft 210, thus, each second roller 220 is capable of rotating in the second direction when the second rotating shaft 210 rotates. In the embodiments, the second roller array is a non-power motivation roller array. That is, each second roller 220 of the second roller array is driven to rotated by a friction generated between a surface thereof and the liquid crystal panel.

A first space defined between two adjacent first roller rows 10 is larger than a thickness of each second roller 220 along the first direction. Thus, friction between the first roller 120 and the corresponding second roller 220 can be prevented from being generated. Each second roller 220 in every two adjacent second rollers rows 20 can rotate relative to each other freely. A second space defined between two adjacent second rollers 220 in each second roller row 20 is larger than a diameter of each first roller 120 along the second direction. Additionally, the diameter of the first roller 120 is smaller than that of the second roller 220.

Referring to FIG. 2, the positioning device includes a first positioning assembly 31, a second positioning assembly 32 opposite to the first positioning assembly 31 along the first direction, a third positioning assembly 33, and a forth positioning assembly 34 opposite to the third positioning assembly 33 along the second direction. The first, second, third, and forth positioning assemblies 31, 32, 33, and 34 are all located above the liquid crystal panel.

The first positioning assembly 31 and the second positioning assembly 32 respectively correspond to a first side 41 and a second side 42 of the liquid crystal panel, and are used for positioning the liquid crystal panel in the first direction before the liquid crystal panel is cut. The first and second positioning assembly 31, 32 are respectively capable of moving along the first direction and the third direction. The first positioning assembly 31 includes a first air cylinder 1a, a first stopper 2a, and a second stopper 2b. The first stopper 2a and the second stopper 2b are connected to the first air cylinder 1a. Thus, the first positioning assembly 31 is capable of applying a first external force along the first direction to the first side 41 of the liquid crystal panel when the first air cylinder 1a pushes the first and second stopper 2a, 2b. The second positioning assembly 32 includes a second air cylinder 1b, a third stopper 2c, and a forth stopper 2d. The third stopper 2c and the forth the stopper 2d are connected to the second air cylinder 1b. Thus, the second positioning assembly 32 is capable of applying a second external force opposite to the first direction to the second side 42 of the liquid crystal panel when the second air cylinder 1b pushes the third and forth stopper 2c, 2d.

The third assembly 33 and the forth positioning assembly 34 respectively correspond to a third side 43 and a forth side 44 of the liquid crystal panel, and are used for positioning the liquid crystal panel in the second direction before the liquid crystal panel is cut. The third and forth positioning assemblies 33, 34 are further capable of moving along the second direction and the third direction. The third positioning assembly 33 includes a third air cylinder 1c, a fifth stopper 2e, and a sixth stopper 2f. The fifth and sixth stoppers 2e, 2f are connected to the third air cylinder 1c. Thus, the third positioning assembly 33 is capable of applying a third external force along the second direction to the third side 43 of the liquid crystal panel when the third air cylinder 1c pushes the fifth and sixth stoppers 2e, 2f. The forth positioning assembly 34 includes a forth air cylinder 1d, a seventh stopper 2g, and an eighth stopper 2h. The seventh and eighth stoppers 2g, 2h are connected to the forth air cylinder 1d. Thus, the forth positioning assembly 34 is capable of applying a forth external force opposite to the second direction to the forth side 44 of the liquid crystal panel when the forth air cylinder 1d pushes the seventh and eighth stoppers 2g, 2h.

It is noted that the configuration of the four positioning assemblies 31˜34 are not limited to this embodiment. In other embodiments, each positioning assembly can apply an external force to the liquid crystal panel by other driving systems, but not the air cylinders such as 1a˜1d in this embodiment.

Since each positioning assembly contacts the corresponding side of the liquid crystal panel via two stoppers thereof, therefore, the contacting area between each positioning assembly and the corresponding side of the liquid crystal panel is increased. Thus, the four positioning assemblies 31˜34 can position the liquid crystal panel stably and precisely. In this state, the number of the air cylinders and the stoppers of each positioning assembly can be adjusted according to actual situations in other embodiments.

With the transferring device and the positioning device of the present disclosure, the cutting machine is capable of positioning the liquid crystal panel respectively in the first direction and the second direction. Therefore, a situation where the liquid crystal panel of large size cannot be positioned precisely can be avoided somewhat and thus the cutting accuracy of the cutting machine can be improved.

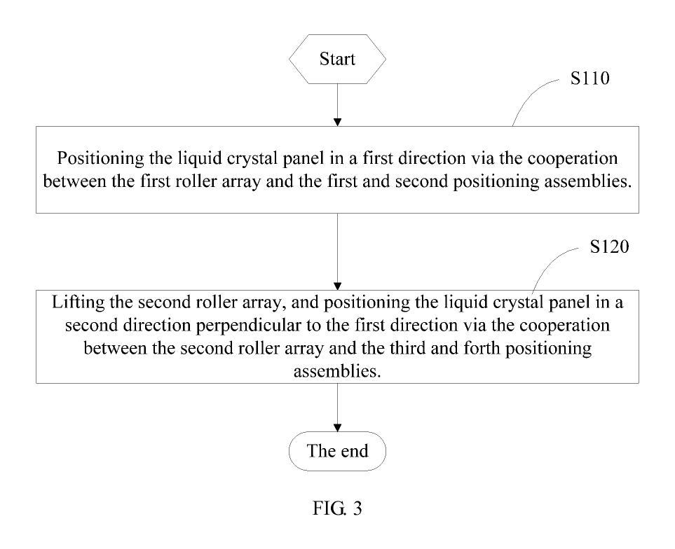

Referring to FIG. 3, a positioning method applied in the cutting machine is provided for positioning a liquid crystal panel by a transferring device and a positioning device. The transferring device includes a first roller array and a second roller array. The positioning device includes a first positioning assembly 31, a second positioning assembly 32, a third positioning assembly 33, and a forth positioning assembly 34. The positioning method includes the following steps:

In step S110, positioning the liquid crystal panel in a first direction via the cooperation between the first roller array and the two positioning assemblies 31, 32. The LCD includes a first side 41, a second side 42 opposite to the first side 41 along the first direction, a third side 43, and a forth side 44 opposite to the third side 43 along a second direction opposite to the first direction. When the liquid crystal panel moves to locate above the first roller array, the first and second positioning assemblies 31, 32 move to respectively correspond to the first and second sides 41, 42. A main body of the cutting machine at this time begins to drive the first and second positioning assemblies 31, 32 to move along the first direction to position the liquid crystal panel in the first direction.

In step S120, lifting the second roller array, and positioning the liquid crystal panel in a second direction perpendicular to the first direction via the cooperation between the second roller array and the two positioning assemblies 33, 34. After the liquid crystal panel is positioned along the first direction, the main body of the cutting machine lifts the second roller array for a predetermined distance. Thus, the liquid crystal panel is driven to leave away from the first roller array. At this time, the third and forth positioning assemblies 33, 34 are respectively driven to move to correspond to the third and forth sides 43, 44 of the liquid crystal panel. In this state, the main body is capable of driving the third and forth positioning assemblies 33, 34 to move along the second direction to allow the liquid crystal panel to be positioned in the second direction.

In the positioning method of the present disclosure, the transferring device and the positioning device are capable of respectively positioning the liquid crystal panel in the first direction and the second direction. Therefore, a situation where the liquid crystal panel of large size cannot be positioned precisely can be avoided and thus the cutting accuracy of the cutting machine can be improved.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A cutting machine for a liquid crystal panel, comprising:
a transferring device for transferring the liquid crystal panel, comprising a first roller array for supporting and transferring the liquid crystal panel along a first direction and a second roller array for supporting and transferring the liquid crystal panel along a second direction;
a positioning device for positioning the liquid crystal panel, comprising a first positioning assembly, a second positioning assembly, a third positioning assembly, and a forth positioning assembly, the first positioning assembly cooperating with the second positioning assembly to position the liquid crystal panel along the first direction before the liquid crystal panel is cut, the third positioning assembly cooperating with the forth positioning assembly to position the liquid crystal panel along the second direction; and
a main body for driving the transferring device and the positioning device to position the liquid crystal panel, and for cutting the liquid crystal panel after the liquid crystal panel is positioned.

2. The cutting machine as claimed in claim 1, wherein the first roller array comprises a plurality of evenly-spaced first roller rows parallel to each other in the first direction, each first roller row comprises a plurality of first rollers arranged in order via a first rotating shaft, and each first roller is capable of rotating in the first direction under the driving of the first rotating shaft; the second roller array comprises a plurality of evenly-spaced second roller rows parallel to each other in the second direction, each second roller row comprises a plurality of second rollers arranged in order via a second rotating shaft, and each second roller is capable of rotating in the second direction under the driving of the second rotating shaft.

3. The cutting machine as claimed in claim 2, wherein the first roller array is a power motivated roller array, and each first roller is driven to rotate when the main body drives the first rotating shaft to rotate.

4. The cutting machine as claimed in claim 2, wherein the second roller array is a non-power motivated roller array, and each second roller is driven to rotate by a friction generated between a surface thereof and the liquid crystal panel.

5. The cutting machine as claimed in claim 4, wherein a first space defined between two adjacent first roller rows is larger than a thickness of each second roller along the first direction, two adjacent second rollers in each second roller row are capable of rotating relative to each other freely, a second space defined between two adjacent second rollers in each second roller row is larger than a diameter of each first roller along the first direction, and the diameter of the each first roller is smaller than that of each second roller.

6. The cutting machine as claimed in claim 5, wherein the second roller array is located under the first roller array, and the second roller array is capable of moving upwards and downwards relative to the first roller array along a third direction perpendicular to the first direction and the second direction.

7. The cutting machine as claimed in claim 1, wherein the liquid crystal panel comprises a first side, a second side opposite to the first side in the first direction, a third side, and a forth side opposite to the third side in the second direction; the first positioning assembly, the second positioning assembly, the third positioning assembly, and the forth positioning assembly are located above the transferring device, the first positioning assembly and the second positioning assembly respectively correspond to the first side and the second side for pushing the first side and the second side along the first direction and a direction opposite to the first direction respectively, the third positioning assembly and the forth positioning assembly respectively correspond to the third side and the forth side for pushing the third side and the forth side along the second direction and a direction opposite to the second direction respectively.

8. The cutting machine as claimed in claim 7, wherein:
the first positioning assembly comprises a first air cylinder, a first stopper, and a second stopper, the first stopper and the second stopper are connected to the first air cylinder, and the first positioning assembly is capable of applying a first external force along the first direction to the first side of the liquid crystal panel when the first air cylinder pushes the first stopper and the second stopper;
the second positioning assembly comprises a second air cylinder, a third stopper, and a forth stopper, the third stopper and the forth stopper are connected to the second air cylinder, and the second positioning assembly is capable of applying a second external force in a direction opposite to the first direction to the second side of the liquid crystal panel when the second air cylinder pushes the third stopper and the forth stopper;
the third positioning assembly comprises a third air cylinder, a fifth stopper, and a sixth stopper, the fifth stopper and the sixth stopper are connected to the third air cylinder, and the third positioning assembly is capable of applying a third external force along the second direction to the third side of the liquid crystal panel when the third air cylinder pushes the fifth stopper and the sixth stopper; and
the forth positioning assembly comprises a forth air cylinder, a seventh stopper, and an eighth stopper, the seventh stopper and the eighth stopper are connected to the first air cylinder, and the forth positioning assembly is capable of applying a forth external force along a direction opposite to the second direction to the forth side of the liquid crystal panel when the forth air cylinder pushes the seventh stopper and the eighth stopper.

9. A positioning method for positioning the liquid crystal panel as claimed in claim 1, comprising the following steps:
providing a first roller array, a first positioning assembly and a second positioning assembly cooperating with the first roller array for positioning the liquid crystal panel along a first direction;
providing a second roller array, a third positioning assembly, and a forth positioning assembly, lifting the second roller array, and positioning the liquid crystal panel along a second direction via cooperation between the second roller array and the third positioning assembly and the forth positioning assembly.

10. A cutting machine of a liquid crystal panel, comprising:
a transferring device for transferring the liquid crystal panel, comprising a first roller array for supporting and transferring the liquid crystal panel along a first direction and a second roller array for supporting and transferring the liquid crystal panel along a second direction;
a positioning device for positioning the liquid crystal panel, comprising a first positioning assembly, a second positioning assembly, a third positioning assembly, and a forth positioning assembly, the first positioning assembly cooperating with the second positioning assembly to position the liquid crystal panel along the first direction before the liquid crystal panel is cut, the third positioning assembly cooperating with the forth positioning assembly to position the liquid crystal panel along the second direction; and
a main body for driving the transferring device and the positioning device to position the liquid crystal panel, and for cutting the liquid crystal panel after the liquid crystal panel is positioned;
wherein the first roller array comprises a plurality of evenly-spaced first roller rows parallel to each other in the first direction, each first roller row comprises a plurality of first rollers arranged in order via a first rotating shaft, and each first roller is capable of rotating in the first direction under the driving of the first rotating shaft; the second roller array comprises a plurality of evenly-spaced second roller rows parallel to each other in the second direction, each second roller row comprises a plurality of second rollers arranged in order via a second rotating shaft, and each second roller is capable of rotating in the second direction under the driving of the second rotating shaft.

11. The cutting machine as claimed in claim 10, wherein the first roller array is a power motivated roller array, and each first roller is driven to rotate when the main body drives the first rotating shaft to rotate.

12. The cutting machine as claimed in claim 10, wherein the second roller array is a non-power motivated roller array, and each second roller is driven to rotate by a friction generated between a surface thereof and the liquid crystal panel.

13. The cutting machine as claimed in claim 10, wherein a first space defined between two adjacent first roller rows is larger than a thickness of each second roller along the first direction, two adjacent second rollers in each second roller row are capable of rotating relative to each other freely, a second space defined between two adjacent second rollers in each second roller row is larger than a diameter of each first roller along the first direction, and the diameter of the each first roller is smaller than that of each second roller.

14. The cutting machine as claimed in claim 13, wherein the second roller array is located under the first roller array, and the second roller array is capable of moving upwards and downwards relative to the first roller array along a third direction perpendicular to the first direction and the second direction.

15. The cutting machine as claimed in claim 10, wherein the liquid crystal panel comprises a first side, a second side opposite to the first side in the first direction, a third side, and a forth side opposite to the third side in the second direction; the first positioning assembly, the second positioning assembly, the third positioning assembly, and the forth positioning assembly are located above the transferring device, the first positioning assembly and the second positioning assembly respectively correspond to the first side and the second side for pushing the first side and the second side along the first direction and a direction opposite to the first direction respectively, the third positioning assembly and the forth positioning assembly respectively correspond to the third side and the forth side for pushing the third side and the forth side along the second direction and a direction opposite to the second direction respectively.

16. The cutting machine as claimed in claim 15, wherein:
the first positioning assembly comprises a first air cylinder, a first stopper, and a second stopper, the first stopper and the second stopper are connected to the first air cylinder, and the first positioning assembly is capable of applying a first external force along the first direction to the first side of the liquid crystal panel when the first air cylinder pushes the first stopper and the second stopper;
the second positioning assembly comprises a second air cylinder, a third stopper, and a forth stopper, the third stopper and the forth stopper are connected to the second air cylinder, and the second positioning assembly is capable of applying a second external force in a direction opposite to the first direction to the second side of the liquid crystal panel when the second air cylinder pushes the third stopper and the forth stopper;
the third positioning assembly comprises a third air cylinder, a fifth stopper, and a sixth stopper, the fifth stopper and the sixth stopper are connected to the third air cylinder, and the third positioning assembly is capable of applying a third external force along the second direction to the third side of the liquid crystal panel when the third air cylinder pushes the fifth stopper and the sixth stopper; and
the forth positioning assembly comprises a forth air cylinder, a seventh stopper, and an eighth stopper, the seventh stopper and the eighth stopper are connected to the first air cylinder, and the forth positioning assembly is capable of applying a forth external force along a direction opposite to the second direction to the forth side of the liquid crystal panel when the forth air cylinder pushes the seventh stopper and the eighth stopper.
